(19) United States
(12) Patent Application Publication
(10) Pub. No.: US 2026/0288587 A1
(43) Pub. Date: Sep. 24, 2026

(54) MANAGING ERROR CORRECTION FOR A DATA PROCESSING SYSTEM USING A MANAGEMENT CONTROLLER

(71) Applicant: Dell Products L.P., Round Rock, TX (US)

(72) Inventors: XIAOMEI ZHU MILLER, Round Rock, TX (US); ADOLFO SANDOR MONTERO, Pflugerville, TX (US); IBRAHIM SAYYED, Georgetown, TX (US); PHANINDRA BHARGAV TALASILA, Georgetown, TX (US)

(21) Appl. No.: 19/085,659

(22) Filed: Mar. 20, 2025

(51) Int. Cl. G06F 11/14; G06F 9/4401; G06F 16/23

(52) U.S. Cl. CPC G06F 11/1417; G06F 9/4406; G06F 16/2365; G06F 2201/805

(57) ABSTRACT

Methods and systems for managing operation of a data processing system are disclosed. To manage the data processing system, a management controller of the data processing system may identify that a data integrity verification process is to be performed for data stored in a boot partition of hardware resources of the data processing system. The management controller may obtain, via a first side band channel, error correction code (ECC) values from a storage device of the hardware resources and may perform, using the ECC values and via a second side band channel, the data integrity verification process to place the data processing system in a desired operating state. Computer-implemented services may be provided by the data processing system in the desired operating state.

### FIELD

Embodiments disclosed herein relate generally to managing operation of a data processing system. More particularly, embodiments disclosed herein relate to managing error correction for the data processing system by using a management controller.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2C show interaction diagrams in accordance with an embodiment.

FIGS. 2D-2E show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may perform a booting process to initialize operation of hardware resources hosted by the data processing system. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

However, the boot data (and/or other data critical to the operation of the data processing system such as firmware images for hardware components) may become corrupted. Data may become corrupted, for example, due to bit flip errors (e.g., undesired and unintentional flips of a bit in memory to the opposite state). Bit flip errors may occur due to interference by cosmic rays and/or due to other causes.

However, if errors go undetected in data such as boot data, critical processes (e.g., a startup process, a shut down process) for the data processing system may not be performed as desired, thereby negatively impact computer-implemented services provided by the data processing system.

To reduce a likelihood of errors going undetected in data such as the boot data, the data processing system may store error correction data (e.g., error correction code (ECC) values). ECC values may allow for identification and correction of errors (e.g., bit flip errors). For example, to detect errors in an 8-bit block of data, a smaller number of extra bits (e.g., 3 bits) may be generated to detect and correct errors in the 8-bit block. The ECC values may be generated (e.g., using an algorithm that processes the original 8 bits and encodes information about their values and/or any other mechanisms) and stored. Therefore, when the processor reads the boot data, it may also read the ECC values to identify if any bits of the boot data have flipped (e.g., the value has changed). If, for example, a single-bit error is detected, the ECC values may be used to identify and correct the specific flipped bit.

The ECC values may be stored, for example, in the boot storage device along with the boot data. However, the ECC values themselves may become corrupted and/or storage of the ECC values in the boot storage device may consume limited storage resources of the boot storage device thereby reducing availability of the limited storage resources for storage of other data such as the boot data.

If the ECC values themselves become corrupted (e.g., undetected errors occur in the ECC values), the ECC values may not be usable to verify integrity of the boot data (and/or other data). Consequently, errors may in the boot data may go undetected and computer-implemented services may not be provided as desired by the data processing system.

To increase a likelihood of identifying and correcting errors in data such as the boot data, a management controller of the data processing system may manage storage of the ECC values in a storage device of hardware resources of the data processing system.

The storage device may include a non-volatile memory (NVMe) storage device that may include a boot partition (e.g., a section of the storage device allocated to store data relevant to the booting process). The management controller may provide and/or obtain (e.g., read and/or write) data from the boot partition using a first side band communication channel. For example, the management controller may store the ECC values in the boot partition of the storage device. By doing so, integrity of a copy of the ECC values stored in the boot storage device may be checked using the ECC values stored in the storage device.

In addition, to reduce resource consumption (e.g., the limited storage resources of the boot storage device), the ECC values may be stored in the boot partition of the storage device and may not be stored in the boot storage device. By offloading storage of the ECC values to the storage device, available storage resources of the boot storage device may be conserved for other purposes. Therefore, the ECC values stored in the storage device may be used to check integrity of the boot data (e.g., and/or other data) without storing a copy of the ECC values in the boot storage device.

If it is determined that a data integrity verification process is to be performed (e.g., integrity of a copy of the ECC values is to be verified, integrity of data such as boot data is to be verified using the ECC values), the management controller may obtain the ECC values stored in the storage device via a first side band channel (e.g., a first side band communication channel). Side band channels of the data processing system may operably connect the management controller to hardware resources of the data processing system (e.g., hardware components such as a processor, the storage device, and the boot storage device). The side band channels may be used to manage (e.g., by the management controller) operation of the hardware components and the side band channels may not be used to provide the computer-implemented services. In contrast, in-band channels of the data processing system may be used during general operation of the data processing system to provide the computer-implemented services.

If the boot storage device stores a copy of the ECC values, the management controller may perform the data integrity verification process (e.g., using the ECC values stored in the storage device) to check integrity of the copy of the ECC values stored in the boot storage device.

If the boot storage device does not store a copy of the ECC values, the management controller may perform the data integrity verification process (e.g., using the ECC values stored in the storage device) to check integrity of boot data stored in the boot storage device.

An integrity verification result may be obtained as a result of performing the data integrity verification process. If the integrity verification result indicates that the data in the boot storage device (e.g., the copy of the ECC values, the boot data) has maintained integrity, the management controller may conclude that a startup for the data processing system is to be performed using the verified boot data and/or that the ECC values are usable to verify integrity of the boot data stored in the boot storage device.

Thus, to improve a likelihood that the data processing system may provide computer-implemented services in a desired operating state, the management controller may manage storage of ECC values in a storage device of the data processing system. The management controller may use the ECC values stored in the storage device to verify integrity of data stored in a boot storage device of the data processing system. By doing so, a likelihood of detecting and correcting errors (e.g., bit flip errors) in data may be increased and a likelihood of providing computer-implemented services as desired may be increased.

In an embodiment, a method for managing operation of a data processing system is provided. The method may include: making an identification, by a management controller of the data processing system, that a data integrity verification process is to be performed for at least a portion of data stored in a boot storage device of hardware resources of the data processing system using error correction code (ECC) values stored in a storage device of the hardware resources; based on the identification: obtaining, by the management controller and via a first side band channel, the ECC values from the storage device; performing, by the management controller and via at least a second side band channel that operably connects the management controller to the boot storage device, the data integrity verification process for the at least the portion of the data stored in the boot storage device using the ECC values to place the data processing system in a desired operating state; and providing, by the data processing system in the desired operating state, computer-implemented services.

The ECC values may not be stored in a boot storage device of the data processing system and the data stored in the boot storage device may include boot data.

The boot data may include at least one type of data selected from a list of types of data consisting of: an image of a startup management entity; and system configuration files.

Performing the data integrity verification process may include: during a startup for the data processing system: checking, using the ECC values and via the second side band channel, integrity of the boot data stored in the boot storage device to obtain an integrity verification result; and in an instance of the checking in which the integrity verification result indicates that the boot data has maintained integrity: initiating completion of the startup to place the data processing system in the desired operating state.

The data stored in the boot storage device may include a copy of the ECC values.

Performing the data integrity verification process may include: checking, using the ECC values stored in the storage device and via the second side band channel, integrity of the copy of the ECC values stored in the boot storage device to obtain an integrity verification result; in an instance of the checking in which the integrity verification result indicates that the copy of the ECC values has maintained integrity: concluding that the copy of the ECC values is usable to verify integrity of boot data stored in the boot storage device.

The method may also include: prior to making the identification: obtaining, by the management controller, the ECC values; storing, by the management controller and via the first side band channel, the ECC values in a boot partition of the storage device.

The management controller may operate independently from and may be distinct from the hardware resources.

The management controller may be on a separate power domain from the hardware resources so that the management controller may be operable while the hardware resources may not be inoperable.

The hardware resources may include: a processor, the boot storage device, and the storage device. The hardware resources may be operably connected by in-band channels used during general operation of the data processing system to provide the computer-implemented services.

The management controller may be operably connected to at least the processor, the boot storage device, and the storage device by side band channels. The side band channels may be used to manage operation of the data processing system and the side band channels may not be used to provide the computer-implemented services.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

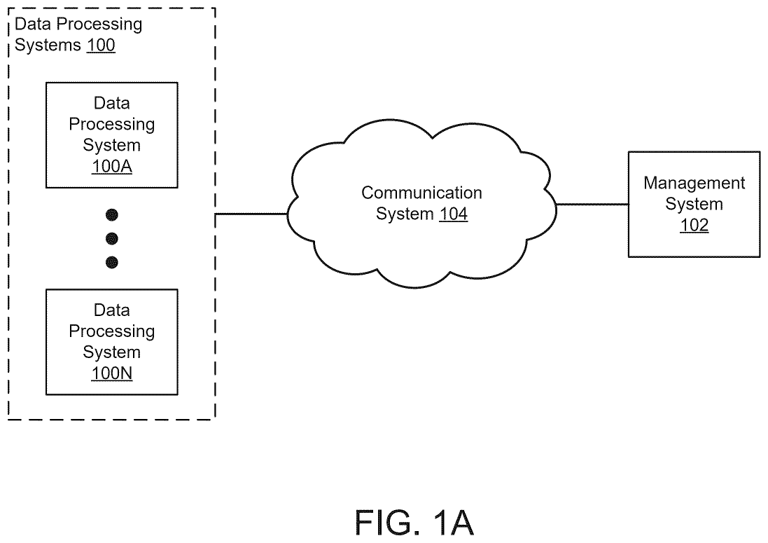

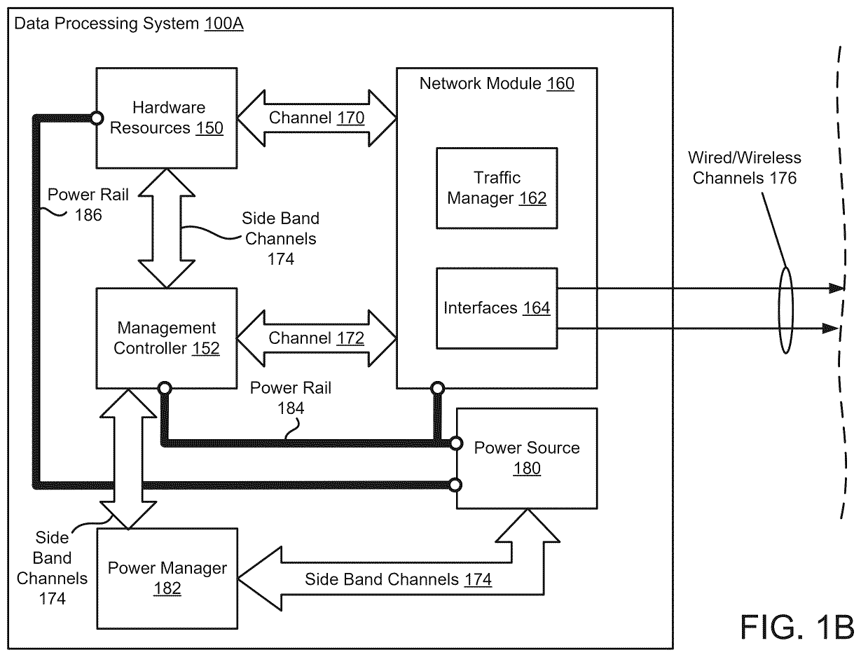

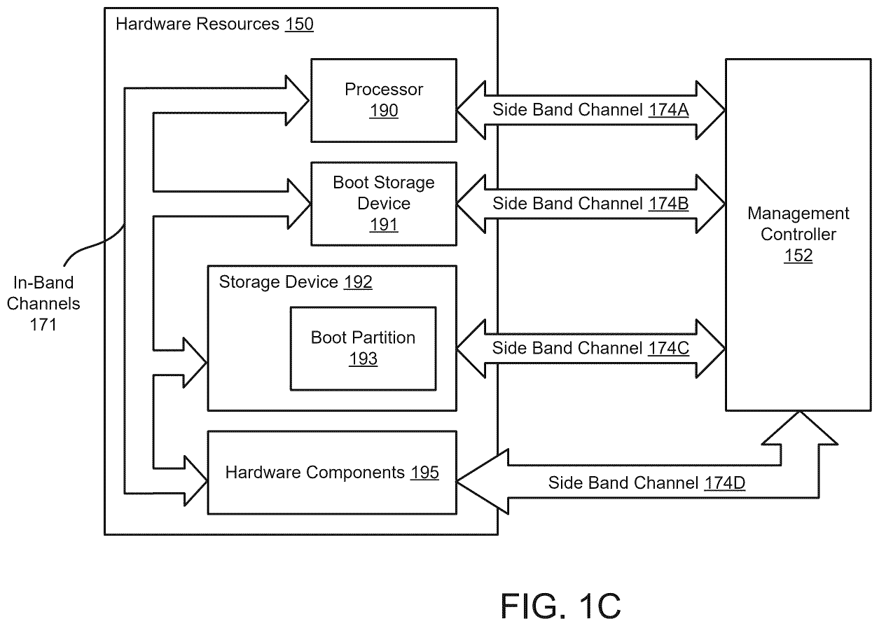

Turning to FIG. 1A, a block diagram illustrating a system in accordance with an embodiment is shown. The system shown in FIG. 1A may provide for management of data processing systems that may provide, at least in part, computer-implemented services (e.g., to users of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band channels) and an operating system may be loaded to provide management functionality.

Prior to using the boot data to perform the booting process, integrity of the boot data may be checked using, at least, ECC values corresponding to the boot data. ECC values may allow for identification and correction of errors (e.g., bit flip errors) in the boot data. A bit flip error may include an undesirable and unintentional flip of a bit to the opposite state thereby corrupting the boot data. Bit flip errors may occur, for example, due to interference from cosmic rays and/or for other reasons.

While described with respect to using ECC values to correct errors in boot data, it may be appreciated that other types of error correction data (e.g., automatic repeat request (ARR) data, redundant array of independent disks (RAID) data, distributed file systems data, data replication data, data mirroring data, continuous data protection data) may be used to detect and correct errors in boot data without departing from embodiments disclosed herein.

For example, to detect errors in an 8-bit block of the boot data, a smaller number of extra bits (e.g., 3 bits) may be generated to detect and correct errors in the 8-bit block. The ECC values may be generated (e.g., using an algorithm that processes the original 8 bits and encodes information about their values and/or any other mechanisms) and stored in the boot storage device. Therefore, when the processor reads the boot data, it may also read the ECC values to identify if any bits of the boot data have flipped (e.g., the value has changed). If, for example, a single-bit error is detected, the ECC values may be used to identify and correct the specific flipped bit. By checking integrity of the boot data using the ECC values, a likelihood of detecting and correcting corrupted boot data may be increased thereby increasing a likelihood of providing computer-implemented services by the data processing system as desired.

However, storing the ECC values in the boot storage device may consume an undesirable quantity of computing resources (e.g., storage resources of the boot storage device) that may otherwise be used to store data critical to the booting process. In addition, the ECC values stored in the boot storage device may themselves become corrupted (e.g., due to cosmic rays and/or other sources of data corruption). Corruption of the ECC values may reduce effectiveness of the ECC values for detecting and correcting errors in the boot data. Therefore, errors may go undetected, and the errors may negatively impact the booting process (e.g., the data processing system may not successfully boot, the data processing system may be placed in an undesirable operating state).

In general, embodiments disclosed herein relate to systems, devices, and methods for managing operation of a data processing system using a management controller. The management controller may manage ECC values for the data processing system in a manner that increases a likelihood that the ECC values will be available for use in verifying integrity of data. To do so, the ECC values may be stored in a storage device of hardware resources of the data processing system via a side band channel (e.g., a side band communication channel).

The storage device may include a non-volatile memory (NVMe) storage device that may include a boot partition (e.g., a section of the storage device allocated to store data relevant to the booting process). The management controller may provide and/or obtain (e.g., read and/or write) data from the boot partition using a first side band communication channel. For example, the management controller may store the ECC codes in the boot partition of the storage device.

A copy of the ECC values may or may not be stored in the boot storage device. If the copy of the ECC values is stored in the boot storage device, the ECC values stored in the storage device may be used to verify integrity of the copy of the ECC values stored in the boot storage device. In addition, if the copy of the ECC values is not stored in the boot storage device, the ECC values stored in the storage device may be used to verify integrity of boot data stored in the boot storage device.

If it is determined that a data integrity verification process is to be performed for at least a portion of data stored in the boot storage device (e.g., the boot data, the copy of the ECC values), the management controller may obtain the ECC values stored in the storage device via a first side band channel and may perform the data integrity verification process using the ECC values obtained from the storage device to obtain an integrity verification result.

Performing the data integrity verification process may include verifying, via a second side band channel that operably connects the management controller to the boot storage device, integrity of data stored in the boot storage device (e.g., the copy of the ECC values, the boot data) using the ECC values obtained from the storage device.

If the integrity verification result indicates that the copy of the ECC values has maintained integrity, the management controller may determine that the copy of the ECC values is usable to verify integrity of boot data stored in the boot storage device. If the integrity verification result indicates that the boot data stored in the boot storage device has maintained integrity, the management controller may determine that a startup process may be completed using the boot data to place the data processing system in a desired operating state.

The data processing system may, therefore, provide computer-implemented services in the desired operating state. Refer to FIG. 1B-1C for additional details regarding side band channels (e.g., side band communication channels).

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may obtain instructions relevant to updated boot software (e.g., an updated firmware version), implementing a boot software recovery policy, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100.

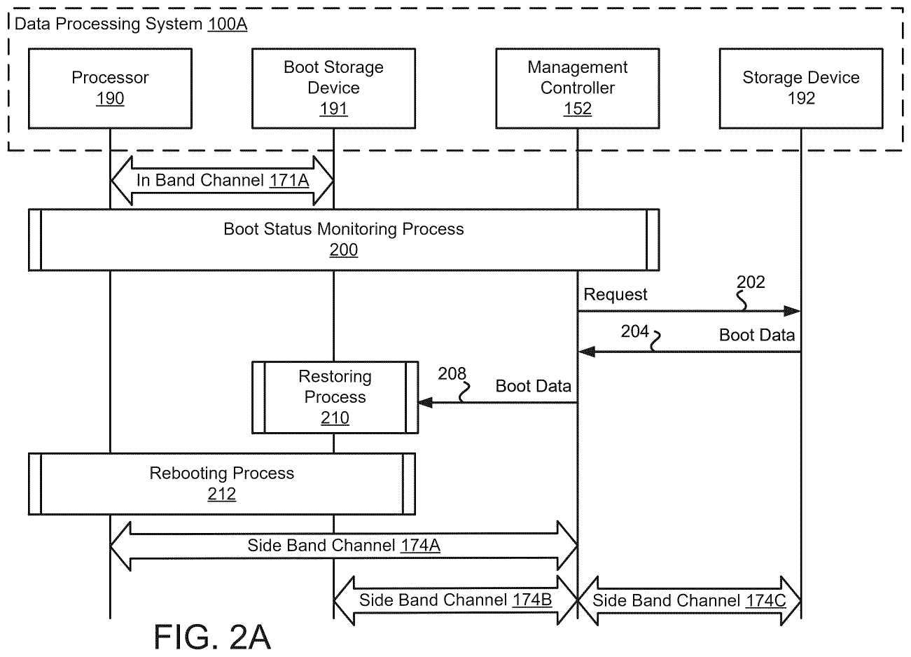

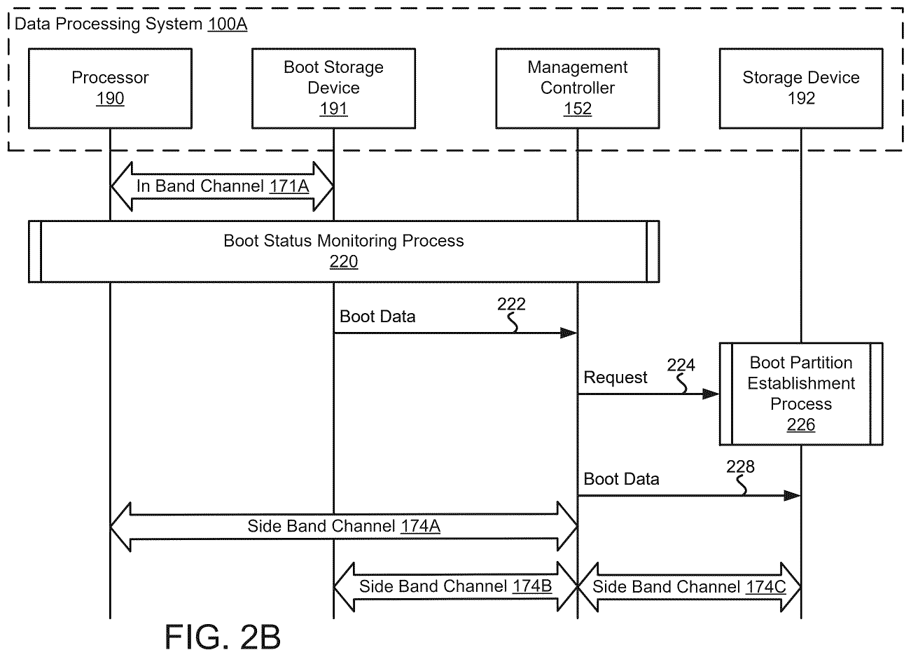

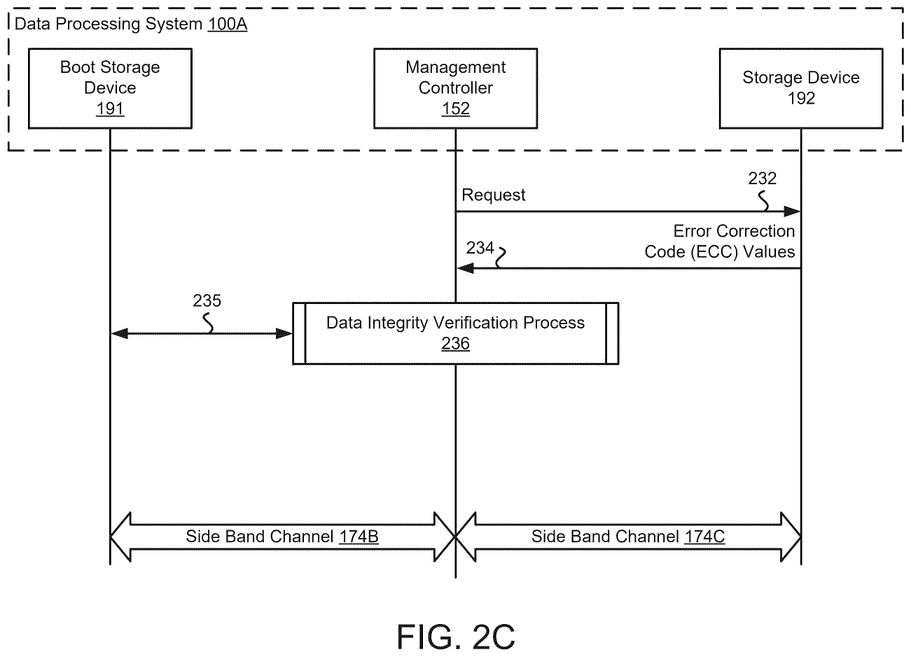

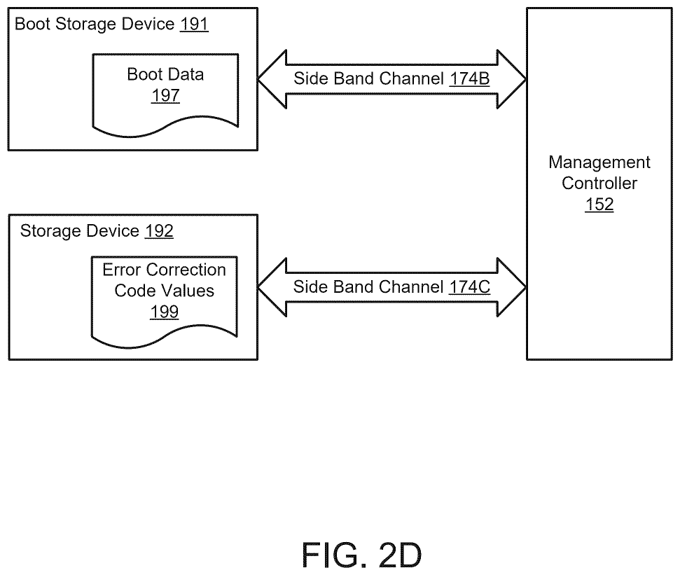

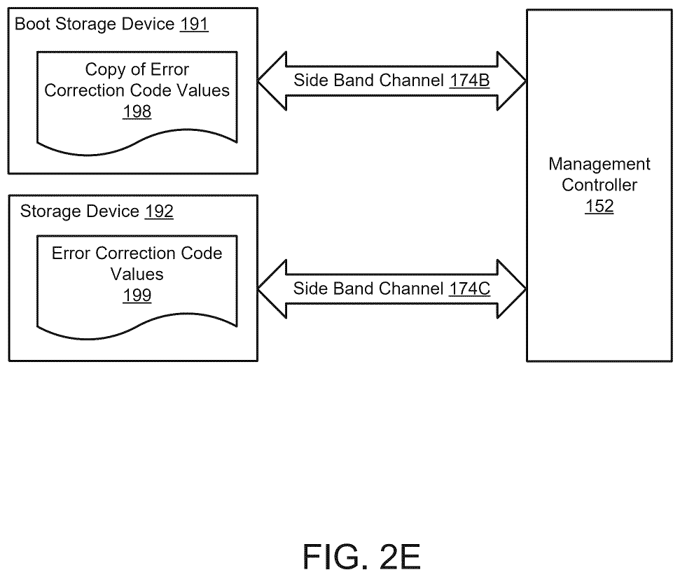

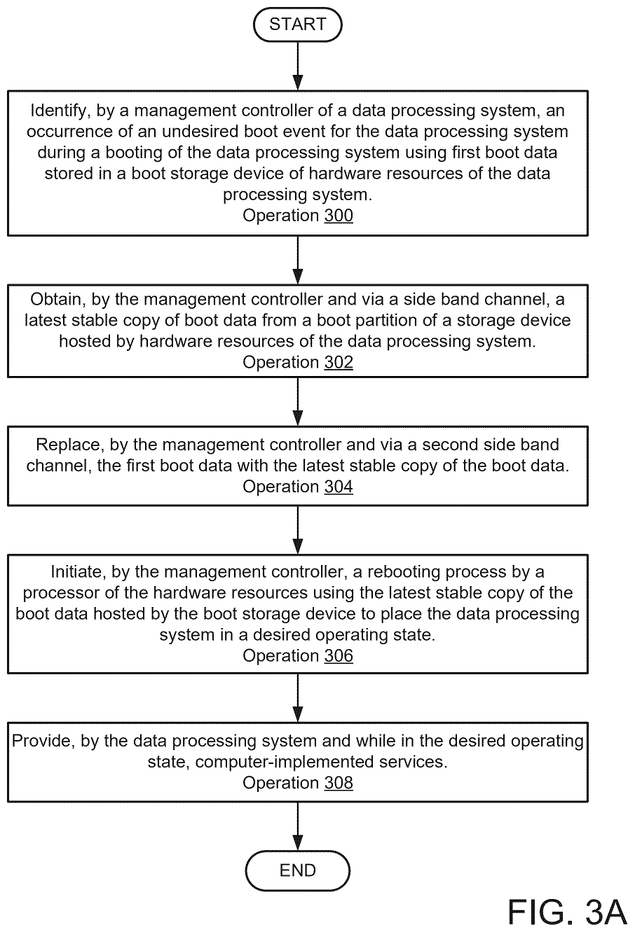

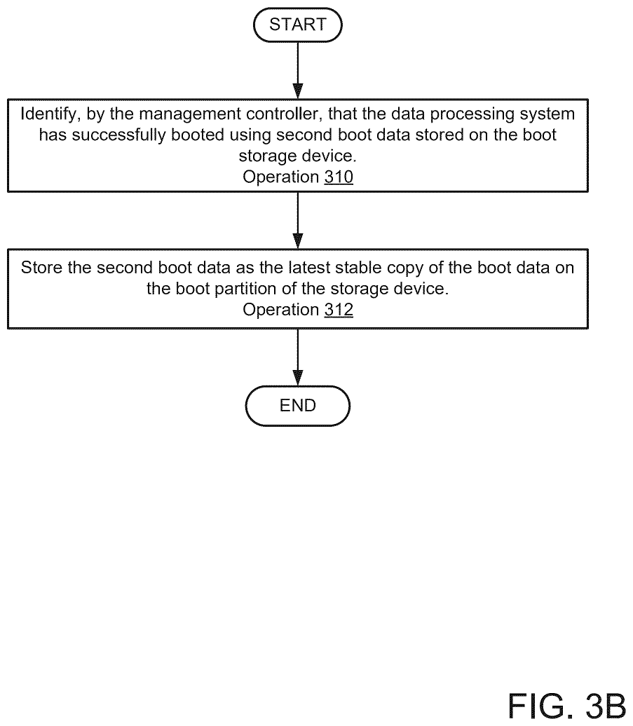

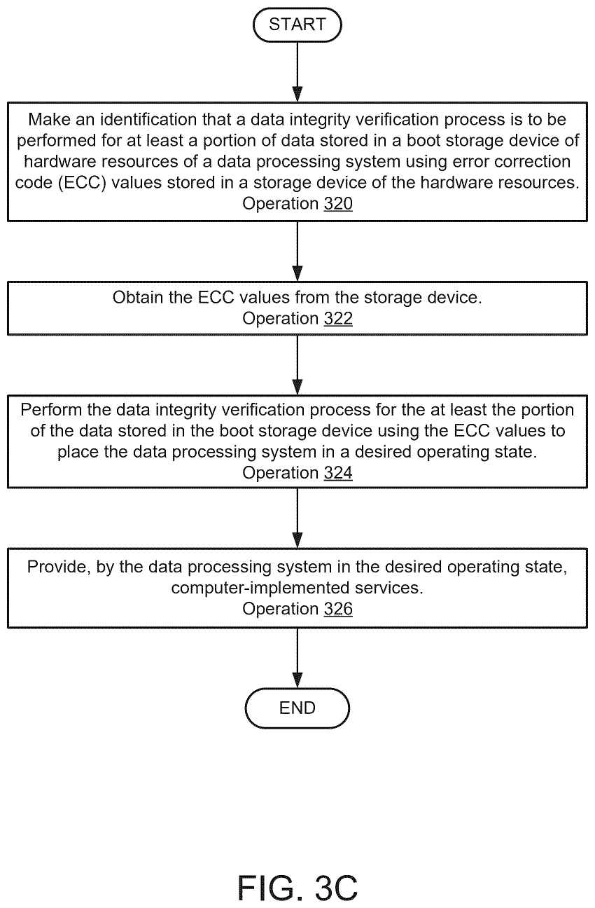

While providing their functionality, any of data processing systems 100, and management system 102 may provide all or a portion of the methods shown in FIGS. 2A-3C.

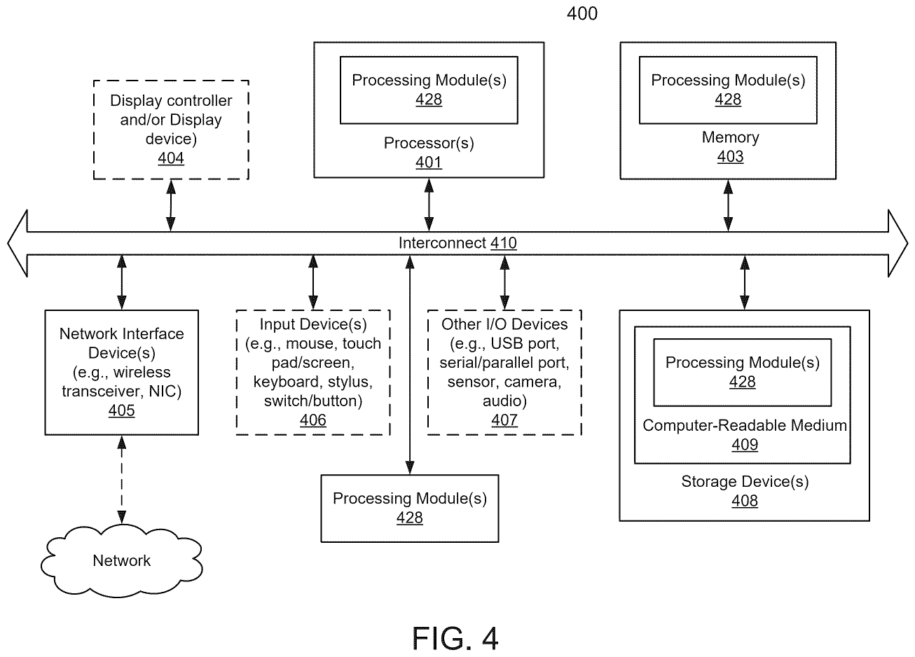

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by storing ECC values in a storage device of hardware resources of the data processing system. By doing so, a likelihood that the ECC values will be available for use in verifying integrity of data critical to a booting process may be increased thereby increasing a likelihood that the data processing system may be placed in a desired operating state.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a boot storage device adapted to host an image of a startup management entity (e.g., basic input/output system (BIOS)), system configurations, and/or any other information. Additionally, the storage may include a storage device that may include, but not be limited to, storage for information necessary to boot the data processing system, load an operating system for the data processing system, and/or perform any other processes. Refer to FIG. 1C for additional information regarding the boot storage device and the storage device.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

Because an ability of management controller 152 to provide the management functionalities may be limited when the data exceeds storage capacity of storage resources hosted by the management controller, management controller 152 may utilize any number and/or types of storage devices hosted by hardware resources 150.

To do so, management controller 152 may be operably connected to various components via side band channels 174 (in FIG. 1B, a limited number of side band channels are included for illustrative purposes, it will be appreciated that management controller 152 may communicate with other components via any number of side band channels). The side band channels may be implemented using separate physical channels, and/or with a logical channel overlay over existing physical channels (e.g., logical division of in-band channels).

The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may: (i) identify that a data integrity verification process is to be performed for at least a portion of data stored in a boot storage device of hardware resources 150, (ii) obtain, via a first side band channel of the side band channels, ECC values from a storage device of hardware resources 150, (iii) perform, via at least a second side band channel, the data integrity verification process to obtain an integrity verification result, and/or (iv) perform other actions. Refer to FIGS. 2C-2E for additional details regarding performing data integrity verification processes using a management controller.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

For example, storage devices of hardware resources 150 may not be operably connected to a processor (e.g., due to in-band channels between the processor and the storage devices not being functional during the booting process). Management controller 152 may communicate with the processor, the boot storage device, and the storage device via side band channels 174. By doing so, management controller 152 may obtain and perform management functionalities (e.g., detecting a system hang during booting, obtaining data from a storage device, restoring boot data on the boot storage device, etc.) regardless of an operating state of hardware resources 150.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3C.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, storage device 192, and hardware components 195 (e.g., other hardware components). For example, to place a data processing system (e.g., 100A) in a desired operating state, data processing system 100A may perform a booting process to initialize hardware resources 150 and facilitate operation of the data processing system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store boot data (e.g., firmware, an image of a management entity (BIOS, universal extensible firmware interface (UEFI), etc.), system configuration files, and/or any other information usable to boot data processing system 100A).

In addition, boot storage device 191 may store ECC values usable to identify and correct errors (e.g., bit flip errors) in the boot data. However, boot storage device 191 may have a limited storage capacity. Therefore, management controller 152 may, via side band channel 174C, store the ECC values in boot partition 193 of storage device 192. The ECC values, therefore, may be stored in both boot storage device 191 and boot partition 193. In addition, the ECC values may be stored in boot partition 193 and not in boot storage device 191 (e.g., thereby conserving the limited storage resources of boot storage device 191).

Storage device 192 may include, for example, a second storage device such as a non-volatile memory express (NVMe) based solid-state drive. Storage device 192 may include boot partition 193 that may be configured to store data usable to boot data processing system 100A (e.g., a latest stable copy of boot data, bootloader files, configuration files, etc.). Boot partition 193 may include an allocated section of storage device 192 that may, for example, be isolated from other memory sections of storage device 192.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171. In-band channels 171 may be used during general operation of the data processing system while providing the computer-implemented services.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of side band channels (e.g. 174). Side band channels 174 may not be used while providing the computer-implemented services.

For example, management controller 152 may: (i) obtain ECC values (e.g., corresponding to boot data stored in boot storage device 191), (ii) manage storage, via side band channel 174C, of the ECC values in boot partition 193 of storage device 192, (iii) perform data integrity verification processes for data stored in boot storage device 191 (e.g., boot data, a copy of the ECC values) via side band channel 174B, (iv) initiate, based on a result of the data integrity verification processes, initiation and/or completion of a startup for the data processing system (e.g., via side band channel 174A and/or side band channel 174D), and/or (v) may perform other actions.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 200 may occur prior to the interaction labeled as 202. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during rebooting of a data processing system when an undesired boot event is identified to have occurred during booting of the data processing system.

To identify that an undesired boot event has occurred, boot status monitoring process 200 may be performed. During boot status monitoring process 200, processor 190 may attempt to boot data processing system 100A using boot data hosted by boot storage device 191, and management controller 152 may monitor the booting process via a side band communication channel. For example, processor 190 may attempt to boot data processing system 100A by receiving a reset signal (e.g., via a power-on process), initializing registers, retrieving data (e.g., BIOS, UEFI, etc.) stored on boot storage device 191 via in-band channel 171A, attempting to execute instructions (e.g., firmware code) based on the data, and/or performing any other actions.

While attempting to boot, processor 190 may be operably connected to boot storage device 191 via in-band channel 171A but may not operably connected to storage device 192 (and/or any other hardware components). In-band channel 171A may include, for example, a limited communication channel between processor 190 and boot storage device 191 that may be facilitated using a signal multiplexer that may enable processor 190 to communicate with boot storage device 191 (e.g., using a system bus) while limiting communication with the other hardware components prior to a management entity (e.g., an operating system, drivers, etc.) being loaded as a result of a successful booting.

Accordingly, management controller 152 may monitor and/or obtain information from processor 190 using side band channel 174A. For example, management controller 152 may obtain data (e.g., telemetry data) from processor 190, compare the data to criteria (e.g., a boot timeout time), and determine that an undesired boot event (e.g., a system hang) has occurred. Based on the identification that an undesired boot event has occurred, management controller may restore a latest stable copy of boot data to boot storage device 191.

At interaction 202, a request may be provided to storage device 192 by management controller 152. The request may be transmitted to storage device 192 via side band channel 174C. The request may indicate, for example, a request to read boot data (e.g., an image of a management entity, firmware, system configuration files, etc.), an identifier for the boot data, a logical block address (e.g., of a boot partition), and/or any other information.

At interaction 204, the boot data may be provided to management controller 152 by storage device 192. For example, the boot data may be provided by: (i) locating the requested boot data (e.g., on the boot partition of storage device 192), (ii) transferring the requested boot data to management controller via side band channel 174C and/or using a data transfer protocol (e.g., non-volatile memory express, universal serial bus, etc.), and/or via any other processes. The boot data may include a version of boot data used during a last successful booting performed for data processing system 100A. Refer to FIG. 2B for additional information regarding obtaining the latest stable copy of the boot data.

Once obtained, the latest stable copy of the boot data may be stored, at least temporarily, by management controller 152. Additionally, management controller 152 may verify at least a portion of the boot data. For example, management controller 152 may verify an integrity of the data (e.g., firmware, system configuration files, etc.).

At interaction 208, the boot data may be provided to boot storage device 191 by management controller 152. For example, the boot data may be provided by transmitting the latest stable copy of the boot data along with instructions (e.g., a write request) via side band channel 174B, utilizing a firmware interface, and/or via any other processes.

To restore the latest stable copy to boot storage device 191, restoring process 210 may be performed. During restoring process 210, a copy of boot data (e.g., that may include erroneous data causing the undesired boot event) hosted by boot storage device 191 may be replaced with the latest stable copy of the boot data. To do so, the existing boot data stored on boot storage device 191 may be removed (e.g., deleted from the non-volatile memory), the latest stable copy of boot data may be written to memory of boot storage device 191, boot storage device 191 be flashed using the latest stable copy of boot data, and/or any other actions may be performed.

Once restored, rebooting process 212 may be performed to attempt to boot data processing system 100A using the latest stable copy of the boot data while hosted on boot storage device 191. Rebooting process 212 may be initiated by management controller 152, as a result of a configuration (e.g., based on an update to storage resources hosted by boot storage device 191), and/or via any other mechanisms. During rebooting process 212, processor 190 may retrieve the boot data from boot storage device 191, execute instructions (e.g., firmware code) based on the boot data, initialize hardware resources, and provide control to a management entity.

By executing the instructions based on the latest stable copy of the boot data, processor 190 may perform operations that may place data processing system 100A in a desired state (e.g., during the last successful booting using the version of the boot data). For example, software and/or hardware resources may be validated (e.g., during a power on self-test), the hardware resources may be configured and/or initialized based on the boot data, an operating system may be loaded to memory of data processing system 100A (e.g., using a bootloader), and/or any other actions may be performed.

Side band channels (e.g., 174A-C) may be used to facilitate communication between management controller 152 and storage device 250, and are shown to indicate that management controller 152 may interface with processor 190, boot storage device 191, and storage device 250 regardless of a status of in-band channels (e.g., that may have reduced functionality due to the undesired boot event). Using the side band channels, management controller 152 may perform management commands that may include, for example, accessing secured data, providing instructions to use the data, obtaining information regarding an operating state of hardware resources 150, installing management entities on hardware resources 150 using the data, and/or performing any other actions.

Thus, using processes and interactions shown in FIG. 2A, a latest stable copy of boot data may be restored, using a management controller, on a boot storage device and used to boot a data processing system in an event that the data processing system is unable to boot using first boot data stored on the boot storage device. By doing so, the data processing system may be placed in a desired operating state for providing computer-implemented services.

Turning to FIG. 2B, a second interaction diagram in accordance with an embodiment is shown. The second interaction diagram may illustrate processes and interactions that may occur during storing of a latest stable copy of boot data used to boot a data processing system.

To store the latest stable copy of boot data, boot status monitor process 220 may be performed. During boot status monitoring process 220, data processing system 100A may be booted, and information regarding the booting may be obtained by management controller 152. For example, data processing system 100A may be booted by: (i) retrieving, by processor 190, the boot data (e.g., image of a management entity, system configuration files, etc.) from boot storage device 191, (ii) executing instructions indicated by the boot data, (iii) initializing hardware resources (e.g., loading firmware-level drivers), (iv) validating a state of the hardware resources, (v) loading an operating system into memory, and/or via any other processes.

During the booting, management controller 152 may obtain information (e.g., telemetry data, processing results, etc.) from processor 190 via side band channel 174A. Based on the information, management controller 152 may identify that the booting was successful (e.g., the operating system was loaded to memory), boot data (e.g., image of management entity, system configurations, etc.) used during booting was updated from a previous version of boot data. and/or any other information.

At interaction 222, boot data may be obtained by management controller 152 from boot storage device 191. The boot data may include, for example, an updated copy of an image of a management entity, system configuration files, firmware, and/or any other information. To obtain the boot data, management controller 152 may transmit a request to access the boot data stored on boot storage device 191 via side band channel 174, the boot data may be transferred to management controller using a communication protocol (e.g., serial peripheral interface) that may be supported by boot storage device 191, the boot data may be transmitted based on an operating system configuration, and/or via any other processes. Once obtained, the boot data may be stored, at least temporarily, by management controller 152.

At interaction 224, a request to store the boot data in a boot partition may be provided to storage device 192 from management controller 152. The request may include, for example, an address for the boot partition if determined by management controller 152 that the boot partition exists, a request to write data to the boot partition, and/or any other information. If determined that the boot partition does not exist, the request may also indicate to storage device that the boot partition is to be created.

To create the boot partition on storage device 192, boot partition establishment process 226 may be performed. During boot partition establishment process 226, a portion of storage resources of storage device 192 may be allocated for boot data. For example, to allocate the portion of storage resources, a size of a partition (e.g., a logical partition) may be configured, the portion of storage resources may be formatted, and/or any other actions may be performed to establish the boot partition. Once established, the boot partition (e.g., 193) may store boot data that may be isolated from other data stored on storage device 192.

At interaction 228, the boot data may be provided to boot partition 193 of storage device 192 for storage. For example, the latest stable copy of boot data may be stored on the boot partition by (i) issuing, by management controller 152, a write request to storage device 192 via side band channel 174C, (ii) identifying, by storage device 192, a physical storage location (e.g., a flash memory cell) for the boot partition, (iii) writing the boot data to the storage location, and/or performing any other actions.

Thus, using processes and interactions shown in FIG. 2B, boot data used during a last successful booting of a data processing system may be stored in a boot partition of a storage device hosted by the data processing system. By doing so, the boot data may be obtained, by a management controller, when an undesired boot event is identified during a future booting of the data processing system and used to initiate a new booting of the data processing system to place the data processing system in a desired operating state.

Turning to FIG. 2C, a third interaction diagram in accordance with an embodiment is shown. The third interaction diagram may illustrate processes and interactions that may occur during performance of a data integrity verification process to check integrity of at least a portion of data stored in boot storage device 191.

To perform the data integrity verification process (e.g., data integrity verification process 236), management controller 152 may obtain ECC values stored in storage device 192.

At interaction 232, management controller 152 may provide a request to storage device 192 (e.g., for the ECC values). The request may be transmitted to storage device 192 via side band channel 174C. The request may indicate, for example, a request to read the ECC values, an identifier for the ECC values, a logical block address (e.g., of a boot partition), and/or any other information.

At interaction 234, the ECC values may be provided to management controller 152 by storage device 192. For example, the ECC values may be provided by: (i) locating the requested ECC values (e.g., on the boot partition of storage device 192), (ii) transferring the requested ECC values to management controller 152 via side band channel 174C and/or using a data transfer protocol (e.g., non-volatile memory express, universal serial bus, etc.), and/or via any other processes.

Management controller 152 may perform data integrity verification process 236 to check integrity of data stored in boot storage device 191. For example, turning to FIG. 2D, an example of types of data stored in storage device 192 and boot storage device 191 is shown. Boot data 197 may be stored in boot storage device 191. Boot data 197 may include, for example, a copy of an image of a management entity, system configuration files, firmware, and/or any other information usable to perform a booting process for the data processing system.

Error correction code (ECC) values 199 may be stored in storage device 192. To conserve limited storage resources of boot storage device 191, a copy of ECC values 199 may not be stored in boot storage device 191. ECC values 199 may data usable to identify and correct errors (e.g., bit flip errors) in boot data 197. For example, to detect errors in an 8-bit block of data of boot data 197, a smaller number of extra bits (e.g., 3 bits) may be generated to detect and correct errors in the 8-bit block. ECC values 199 may be generated (e.g., using an algorithm that processes the original 8 bits and encodes information about their values and/or any other mechanisms) and stored in storage device 192.

Management controller 152 may, therefore, obtain ECC values 199 (e.g., via interactions 232 and 234 in FIG. 2C) to identify if any bits of the boot data have flipped (e.g., the value has changed) during data integrity verification process 236. If, for example, a single-bit error is detected, ECC values 199 may be used to identify and correct the specific flipped bit.

Returning to FIG. 2C, during data integrity verification process 236, management controller 152 may check integrity of boot data stored in boot storage device 191. For example, data integrity verification process 236 may include interaction 235 between management controller 152 and boot storage device 191. Management controller 152 may perform an error identification and correction process (e.g., may execute an algorithm) to check the integrity of the boot data using the ECC values to obtain an integrity verification result. The integrity verification result may indicate whether any errors were identified and/or corrected in the boot data.

Boot storage device 191 may also store a copy of ECC codes corresponding to the boot data. Therefore, management controller 152 may perform data integrity verification process 236 to check integrity of the copy of the ECC values stored in boot storage device 191. For example, turning to FIG. 2E, an example of types of data stored in storage device 192 and boot storage device 191 is shown.

Storage device 192 may store ECC values 199 and boot storage device 191 may store copy of error correction code values 198. Boot storage device 191 may also store boot data (e.g., not shown). Copy of ECC values 198 may include same data as ECC values 199 (e.g., refer to FIG. 2D for a description of ECC values 199). Therefore, management controller 152 may obtain ECC values 199 (e.g., via interactions 232 and 234 in FIG. 2C) to check integrity of copy of ECC values 198 during data integrity verification process 236.

Returning to FIG. 2C, during data integrity verification process 236, management controller may check integrity of the copy of the ECC values stored in boot storage device 191. For example, data integrity verification process 236 may include interaction 235 between management controller 152 and boot storage device 191. Management controller 152 may compare, via any methods, the ECC values obtained from storage device 192 to the copy of the ECC values stored in boot storage device 191 to obtain an integrity verification result. The integrity verification result may indicate whether any errors were identified and/or corrected in the copy of the ECC values.

Thus, using processes and interactions shown in FIGS. 2C-2E, ECC values may be used to check integrity of data (e.g., boot data, a copy of the ECC values). By doing so, a likelihood that boot data may maintain integrity during a future startup for the data processing system may be increased thereby increasing a likelihood of providing desired computer-implemented services based, at least in part, on an operating state of the data processing system during general operation.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIGS. 3A-3C illustrate methods that may be performed by the components of the system of FIGS. 1A-1C. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of managing operation of a data processing system in accordance with an embodiment is shown. The method may be performed, for example, by any of the components of the system of FIGS. 1A-1C, and/or other components not shown therein.

Prior to operation 300, a latest stable copy of boot data used during a last successful booting of the data processing system may be stored in a boot partition of a storage device of hardware resources of the data processing system. The latest stable copy of boot data may include, for example, a first version of boot data (e.g., image of a management entity, system configuration files, firmware, etc.), an updated version of the first version of boot data, and/or any other information. Refer to FIG. 3B for additional information regarding obtaining the latest stable copy of the boot data.

At operation 300, an occurrence of an undesired boot event for the data processing system during a booting of the data processing system may be identified. The occurrence of the undesired boot event may be identified by a management controller of the data processing system. Because in-band channels may have limited functionality during the booting and/or as a result of the undesired boot event, the management controller may obtain information (e.g., telemetry data, results of processes performed, etc.) regarding the booting from a processor of the data processing system using a side band channel. For example, management controller 152 may detect that a system hang (e.g., a boot timeout) based on the information.

At operation 302, the latest stable copy of boot data may be obtained from the boot partition by the management controller and using a side band channel. The latest stable copy of boot data may be obtained by: (i) transmitting a read request (e.g., an identifier, file address, etc.) to the storage device for the latest stable copy of boot data, (ii) locating, by the storage device, the requested latest stable copy of boot data, (iii) transmitting the latest stable copy of the boot data via the side band channel and/or using a data transfer protocol (e.g., NVMe), validating an integrity of the latest stable copy of the boot data, and/or via any other processes.

At operation 304, the first boot data hosted by the boot storage device may be replaced with the latest stable copy of the boot data. The first boot data may be replaced by: (i) flashing boot storage device (e.g., an SPI flash storage device) with the latest stable copy of boot data, (ii) erasing the first boot data from the boot storage device and writing the latest stable copy of the boot data to the boot storage device, (iii) overwriting the first boot data with the latest stable copy of the boot data, and/or performing any other actions. To do so, management controller may communicate with the boot storage device using a second side band channel.

At operation 306, a rebooting process may be initiated by the management controller for a processor using the latest stable copy of the boot data. The rebooting process may be initiated by: (i) sending a reset signal to the processor, (ii) triggering a new booting process based on an update to the boot storage device, (iii) executing instructions indicated by the latest stable copy of the boot data, (iv) loading an operating system into memory of the data processing system, and/or performing any other actions to place the data processing system in a desired operating state.

At operation 308, computer-implemented services may be provided by the data processing system and while in the desired operating state. The computer-implemented services may be provided by: (i) installing a new management entity (e.g., an application, driver, firmware etc.), (ii) providing an interface for a user of the data processing system, and/or via any other processes.

The method may end following operation 308.

Using the method shown in FIG. 3A, operation of a data processing system may be managed using a management controller to restore boot data hosted by a boot storage device in an event that an undesired boot event is identified during an attempted booting of the data processing system. By doing so, the data processing system may be booted to a desired operating state.

Turning to FIG. 3B, a second flow diagram illustrating a method of storing a latest stable copy of boot data to a boot partition of a storage device is shown. The method may be performed, for example, by any of the components of the system of FIGS. 1A-1C, and/or other components not shown therein.

At operation 310, it may be identified by the management controller that the data processing system has successfully booted using boot data stored on the boot storage device. The management controller may identify that the data processing system has successfully booted by: (i) monitoring a boot status via a side band communication channel between the management controller and the processor, (ii) obtaining telemetry data from the processor, (iii) identifying execution of an operating system kernel, and/or via any other processes.

At operation 312, the second boot data may be stored as the latest stable copy of the boot data on a boot partition of a storage device. The latest stable copy of the boot data may be stored by: (i) identifying whether a boot partition exists on the storage device, (ii) cooperatively, between the management controller and the storage device, allocating a portion of storage resources of the storage device to create the boot partition in an instance where the boot partition does not exist, (iii) issuing, by the management controller, a write request to the storage device to store the latest stable copy of the boot data to the boot partition, and/or via any other processes.

The method may end following operation 312.

Using the method shown in FIG. 3B, a boot data used by the data processing system during a last successful booting may be identified by a management controller and stored in a boot partition of a storage device. By doing so, the boot data may be used by the management controller to replace undesired boot data during a future attempted booting of the data processing system.

Turning to FIG. 3C, a third flow diagram illustrating a method of managing operation of a data processing system is shown using a management controller. The method may be performed, for example, by any of the components of the system of FIGS. 1A-1C, and/or other components not shown therein.

At operation 320, an identification may be made that a data integrity verification process is to be performed for at least a portion of data stored in a boot storage device of hardware resources of the data processing system using ECC values stored in a storage device of the data processing system. Making the identification may include: (i) identifying that a startup for the data processing system is to be performed and that integrity of the at least the portion of the data stored in the boot storage device is to be checked as part of the startup, (ii) identifying that integrity of the at least the portion of the data stored in the boot storage device is to be checked at other times (e.g., prior to shutting down the data processing system, in response to an elevated threat level that may indicate corruption of the at least the portion of the data stored in the boot storage device), and/or (iii) other methods.

At operation 322, the ECC values may be obtained from the storage device. Obtaining the ECC values may include: (i) providing a request to the storage device (e.g., via a side band channel of the data processing system and by a management controller of the data processing system) and receiving the ECC values in response to the request, (ii) reading the ECC values from the storage device, and/or (iii) other methods.

At operation 324, the data integrity verification process may be performed for the at least the portion of the data stored in the boot storage device using the ECC values to place the data processing system in a desired operating state. The data integrity verification process may be performed during a startup for the data processing system. Performing the data integrity verification process may include: (i) checking, using the ECC values and via a second side band channel, integrity of boot data stored in the boot storage device to obtain an integrity verification result, (ii) initiating (e.g., in an instance of the checking in which the integrity verification result indicates that the boot data has maintained integrity) completion of the startup to place the data processing system in the desired operating state, and/or (iii) other methods.

Checking the integrity of the boot data may include: (i) performing, using the ECC values, an algorithm to identify and correct errors in the boot data, (ii) providing the ECC values to another entity responsible for performing the algorithm, and/or (iii) other data.

Initiating the completion of the startup may include: (i) providing a notification to another entity (e.g., a startup management entity, a processor) indicating that the boot data has maintained integrity and is usable to perform the startup, (ii) generating a log entry in an event log indicating that the boot data has maintained integrity, and/or (iii) other methods.

The data integrity verification process may also be performed at other times (e.g., prior to shutting down the data processing system, in response to an indication that at least a portion of data stored in the boot storage device may be corrupted). Performing the data integrity verification process may also include: (i) checking, using the ECC values stored in the storage device and via the second side band channel, integrity of a copy of the ECC values stored in the boot storage device, (ii) concluding (e.g., in an instance of the checking in which the integrity verification result indicates that the copy of the ECC values has maintained integrity) that the copy of the ECC values is usable to verify integrity of boot data stored in the boot storage device, and/or (iii) other methods.

Checking the integrity of the copy of the ECC values may include: (i) comparing a content of the ECC values obtained from the storage device to a content of the copy of the ECC values stored in the boot storage device, (ii) performing any comparison algorithm to obtain a difference between the content of the ECC values and the content of the copy of the ECC values, (iii) providing the ECC values and the copy of the ECC values to another entity and obtaining the difference in response, and/or (iv) other methods.

Concluding that the copy of the ECC values are usable to verify integrity of the boot data may include: (i) generating a log entry in an event log indicating that the copy of the ECC values has maintained integrity, (ii) notifying another entity that the copy of the ECC values has maintained integrity, (iii) performing other processes (e.g., checking integrity of the boot data using the copy of the ECC values and/or the ECC values), and/or (iv) other methods.

At operation 326, computer-implemented services may be provided by the data processing system in the desired operating state. Providing the computer-implemented services may include: (i) providing a user access to data stored by the data processing system, (ii) providing the user with access to functionality of hardware and/or software resources of the data processing system, and/or (iii) other methods.

The method may end following operation 326.

Prior to making the identification, the management controller of the data processing system may: (i) obtain the ECC values (e.g., read the ECC values from storage, receive the ECC values from a trusted entity via a communication system, generate the ECC values based on boot data), (ii) store, by the management controller and via the first side band channel, the ECC values in a boot partition of the storage device. Storing the ECC values in the boot partition may include: (i) identifying whether a boot partition exists on the storage device, (ii) cooperatively, between the management controller and the storage device, allocating a portion of storage resources of the storage device to create the boot partition in an instance where the boot partition does not exist, (iii) issuing, by the management controller, a write request to the storage device to store the ECC values to the boot partition, and/or via any other processes.

Any of the components illustrated in FIGS. 1A-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making an identification, by a management controller of the data processing system, that a data integrity verification process is to be performed for at least a portion of data stored in a boot storage device of hardware resources of the data processing system using error correction code (ECC) values stored in a storage device of the hardware resources;
based on the identification:
obtaining, by the management controller and via a first side band channel, the ECC values from the storage device;
performing, by the management controller and via at least a second side band channel that operably connects the management controller to the boot storage device, the data integrity verification process for the at least the portion of the data stored in the boot storage device using the ECC values to place the data processing system in a desired operating state; and
providing, by the data processing system in the desired operating state, computer-implemented services.

2. The method of claim 1, wherein the ECC values are not stored in a boot storage device of the data processing system and the data stored in the boot storage device comprises boot data.

3. The method of claim 2, wherein the boot data comprises at least one type of data selected from a list of types of data consisting of:
an image of a startup management entity; and
system configuration files.

4. The method of claim 2, wherein performing the data integrity verification process comprises:
during a startup for the data processing system:
checking, using the ECC values and via the second side band channel, integrity of the boot data stored in the boot storage device to obtain an integrity verification result; and
in an instance of the checking in which the integrity verification result indicates that the boot data has maintained integrity:
initiating completion of the startup to place the data processing system in the desired operating state.

5. The method of claim 1, wherein the data stored in the boot storage device comprises a copy of the ECC values.

6. The method of claim 5, wherein performing the data integrity verification process comprises:
checking, using the ECC values stored in the storage device and via the second side band channel, integrity of the copy of the ECC values stored in the boot storage device to obtain an integrity verification result; and
in an instance of the checking in which the integrity verification result indicates that the copy of the ECC values has maintained integrity:
concluding that the copy of the ECC values is usable to verify integrity of boot data stored in the boot storage device.

7. The method of claim 1, further comprising:
prior to making the identification:
obtaining, by the management controller, the ECC values; and
storing, by the management controller and via the first side band channel, the ECC values in a boot partition of the storage device.

8. The method of claim 1, wherein the management controller operates independently from and is distinct from the hardware resources.

9. The method of claim 8, wherein the management controller is on a separate power domain from the hardware resources so that the management controller is operable while the hardware resources are inoperable.

10. The method of claim 1, wherein the hardware resources comprise:
a processor,
the boot storage device, and
the storage device, and
wherein the hardware resources are operably connected by in-band channels used during general operation of the data processing system to provide the computer-implemented services.

11. The method of claim 10, wherein the management controller is operably connected to at least the processor, the boot storage device, and the storage device by side band channels, the side band channels being used to manage operation of the data processing system and the side band channels not being used to provide the computer-implemented services.

12. A non-transitory machine-readable medium having instructions stored therein, which when executed by a processor, cause the processor to perform operations for managing operation of a data processing system, the operations comprising:
making an identification, by a management controller of the data processing system, that a data integrity verification process is to be performed for at least a portion of data stored in a boot storage device of hardware resources of the data processing system using error correction code (ECC) values stored in a storage device of the hardware resources;
based on the identification:
obtaining, by the management controller and via a first side band channel, the ECC values from the storage device;
performing, by the management controller and via at least a second side band channel that operably connects the management controller to the boot storage device, the data integrity verification process for the at least the portion of the data stored in the boot storage device using the ECC values to place the data processing system in a desired operating state; and
providing, by the data processing system in the desired operating state, computer-implemented services.

13. The non-transitory machine-readable medium of claim 12, wherein the ECC values are not stored in a boot storage device of the data processing system and the data stored in the boot storage device comprises boot data.

14. The non-transitory machine-readable medium of claim 13, wherein the boot data comprises at least one type of data selected from a list of types of data consisting of:
an image of a startup management entity; and
system configuration files.

15. The non-transitory machine-readable medium of claim 13, wherein performing the data integrity verification process comprises:
during a startup for the data processing system:
checking, using the ECC values and via the second side band channel, integrity of the boot data stored in the boot storage device to obtain an integrity verification result; and
in an instance of the checking in which the integrity verification result indicates that the boot data has maintained integrity:
initiating completion of the startup to place the data processing system in the desired operating state.

16. The non-transitory machine-readable medium of claim 12, wherein the data stored in the boot storage device comprises a copy of the ECC values.

17. A data processing system, comprising:
a processor; and
a memory coupled to the processor to store instructions, which when executed by the processor, cause the processor to perform operations for managing operation of a data processing system, the operations comprising:
making an identification, by a management controller of the data processing system, that a data integrity verification process is to be performed for at least a portion of data stored in a boot storage device of hardware resources of the data processing system using error correction code (ECC) values stored in a storage device of the hardware resources;
based on the identification:
obtaining, by the management controller and via a first side band channel, the ECC values from the storage device;
performing, by the management controller and via at least a second side band channel that operably connects the management controller to the boot storage device, the data integrity verification process for the at least the portion of the data stored in the boot storage device using the ECC values to place the data processing system in a desired operating state; and
providing, by the data processing system in the desired operating state, computer-implemented services.

18. The data processing system of claim 17, wherein the ECC values are not stored in a boot storage device of the data processing system and the data stored in the boot storage device comprises boot data.

19. The data processing system of claim 18, wherein the boot data comprises at least one type of data selected from a list of types of data consisting of:
an image of a startup management entity; and
system configuration files.

20. The data processing system of claim 18, wherein performing the data integrity verification process comprises:
during a startup for the data processing system:
checking, using the ECC values and via the second side band channel, integrity of the boot data stored in the boot storage device to obtain an integrity verification result; and
in an instance of the checking in which the integrity verification result indicates that the boot data has maintained integrity:
initiating completion of the startup to place the data processing system in the desired operating state.
